(19) United States
(12) Patent Application Publication
(10) Pub. No.: US 2026/0369724 A1
(43) Pub. Date: Nov. 19, 2026

(54) BATTERY PACK WITH HEAT DISSIPATING PARTS

(71) Applicant: MILWAUKEE ELECTRIC TOOL CORPORATION, Brookfield, WI (US)

(72) Inventors: Shang Hong Wang, Dongguan City (CN); Ming Kang Huang, Dongguan City (CN); Dao Yuan Liu, Dongguan City (CN)

(21) Appl. No.: 19/673,059

(22) Filed: May 11, 2026

(30) Foreign Application Priority Data
May 13, 2025 (CN) 202520934813.1

(51) Int. Cl. H01M 10/653; H01M 10/6235; H01M 10/643; H01M 10/6551; H01M 50/213; H01M 50/247; H01M 50/262; H01M 50/291; H01M 50/30; H01M 50/507

(52) U.S. Cl. CPC H01M 10/653; H01M 10/6235; H01M 10/643; H01M 10/6551; H01M 50/213; H01M 50/247; H01M 50/262; H01M 50/291; H01M 50/394; H01M 50/507; H01M 2220/30

(57) ABSTRACT

A battery pack may include a housing made from a first material having a first thermal conductivity, the housing defining a cavity, and an interface configured to couple to a power tool. A battery pack may include a cell frame supported within the cavity of the housing, the cell frame including a cell core including a plurality of apertures to secure a plurality of battery cells, a first cell end frame disposed adjacent to the cell core, the first cell end frame surrounding a first portion of the battery cells, and a second cell end frame disposed adjacent to the cell core opposite the first cell end frame, the second cell end frame surrounding a second portion of the battery cells, wherein the first cell end frame and the second cell end frame are made from a second material having a second thermal conductivity greater than the first thermal conductivity.

### FIELD

The present disclosure relates to battery packs, including battery packs for power tools.

### BACKGROUND

Battery packs typically generate heat during use and during charging. As demands on battery packs increase to provide a greater amount of power and performance or a faster charging time, a need exists for battery packs with improved ability to dissipate heat.

### SUMMARY

In some aspects, the techniques described herein relate to a battery pack including: a housing made from a first material having a first thermal conductivity, the housing defining a cavity, and an interface configured to couple to a power consumption device; and a cell frame supported within the cavity of the housing, the cell frame including a cell core including a plurality of apertures to support a plurality of battery cells, a first cell end frame disposed adjacent to the cell core, the first cell end frame surrounding a first portion of the battery cells, and a second cell end frame disposed adjacent to the cell core opposite the first cell end frame, the second cell end frame surrounding a second portion of the battery cells; wherein the first cell end frame and the second cell end frame are made from a second material having a second thermal conductivity greater than the first thermal conductivity.

In some aspects, the techniques described herein relate to a battery pack, wherein the first cell end frame surrounds a first end of the battery cells and the second cell end frame surrounds a second end of the battery cells.

In some aspects, the techniques described herein relate to a battery pack, wherein the first cell end frame and the second cell end frame surround a majority of a surface area of each of the plurality of battery cells.

In some aspects, the techniques described herein relate to a battery pack, further including a plurality of conductive straps coupled to the battery cells.

In some aspects, the techniques described herein relate to a battery pack, wherein the first cell end frame and the second cell end frame each include an end plate with through-holes to expose the conductive straps.

In some aspects, the techniques described herein relate to a battery pack, wherein the conductive straps are molded in the first cell end frame or the second cell end frame, or the conductive straps are positioned between the battery cells and the end plate.

In some aspects, the techniques described herein relate to a battery pack, wherein the second thermal conductivity is equal to or greater than 2.0 watts per meter kelvin.

In some aspects, the techniques described herein relate to a battery pack, wherein the first cell end frame and the second cell end frame each have a Shore A hardness greater than or equal to 40 and less than or equal to 70.

In some aspects, the techniques described herein relate to a battery pack, wherein the first cell end frame and the second cell end frame each have a hardness greater than that of the cell core, wherein the interface is fixed to the cell core.

In some aspects, the techniques described herein relate to a battery pack, wherein the first cell end frame includes a first plurality of fins spanning a perimeter of the first cell end frame and wherein the second cell end frame includes a second plurality of fins spanning a perimeter of the second cell end frame.

In some aspects, the techniques described herein relate to a battery pack, wherein the housing includes a plurality of vents disposed adjacent to the first plurality of fins and the second plurality of fins.

In some aspects, the techniques described herein relate to a battery pack, wherein the second thermal conductivity is at least twice the first thermal conductivity.

In some aspects, the techniques described herein relate to a battery pack, wherein the housing further includes an upper portion defining the interface, a lower portion opposite the upper portion, a first side portion disposed between the upper portion and the lower portion, and a second side portion disposed between the upper portion and the lower portion, the second side portion positioned opposite the first side portion, wherein the upper portion, the lower portion, the first side portion, and the second side portion cooperate to form the cavity.

In some aspects, the techniques described herein relate to a battery pack, wherein the upper portion is coupled to the first side portion through a first fastener, and the first side portion is coupled to the lower portion through a second fastener.

In some aspects, the techniques described herein relate to a battery pack, wherein each of the upper portion, the lower portion, the first side portion, and the second side portion includes at least one bore for receiving a fastener along a direction parallel to longitudinal axes of the plurality of battery cells.

In some aspects, the techniques described herein relate to a battery pack, wherein the housing includes a top housing and a bottom housing, the bottom housing forms the cavity.

In some aspects, the techniques described herein relate to a battery pack including: a housing defining a plurality of vents; and a cell frame supported within the housing, the cell frame including a cell core including a plurality of apertures to secure a plurality of battery cells, and a cell end frame disposed adjacent to the cell core, the cell end frame surrounding a first portion of the plurality of battery cells and defining a first plurality of fins spanning a perimeter of the first cell end frame.

In some aspects, the techniques described herein relate to a battery pack, wherein the plurality of vents is disposed adjacent to the first plurality of fins such that heat is dissipated from the first plurality of fins through the plurality of vents.

In some aspects, the techniques described herein relate to a battery pack further including a plurality of conductive straps coupled to the battery cells, wherein the plurality of conductive straps is disposed between the plurality of battery cells and the cell end frame.

In some aspects, the techniques described herein relate to a battery pack, wherein the cell end frame defines a plurality of openings disposed adjacent to the plurality of battery cells.

In some aspects, the techniques described herein relate to a battery pack, wherein the cell end frame is made of a material having a thermal conductivity equal to or greater than 2.0 watts per meter kelvin.

Other aspects of the embodiments will become apparent by consideration of the detailed description and accompanying drawings.

### BRIEF DESCRIPTION OF THE DRAWINGS

FIG. 1 is a perspective view of a battery pack according to some constructions.

FIG. 2 is an exploded view of the battery pack of FIG. 1, according to some constructions.

FIG. 3 is a side cross-sectional view taken from line 3-3 in FIG. 1, according to some constructions.

FIG. 4 is a perspective view of a cell frame of a battery pack of FIG. 1, according to some constructions.

FIG. 5 is an exploded view of the cell frame of FIG. 4, according to some constructions.

FIG. 6 is a perspective view of a cell end frame of the cell frame of FIG. 4, according to some constructions.

### DETAILED DESCRIPTION

Before any independent constructions of the disclosure are explained in detail, it is to be understood that the disclosure is not limited in its application to the details of construction and the arrangement of components set forth in the following description or illustrated in the following drawings. The disclosure is capable of other independent constructions and of being practiced or of being carried out in various ways.

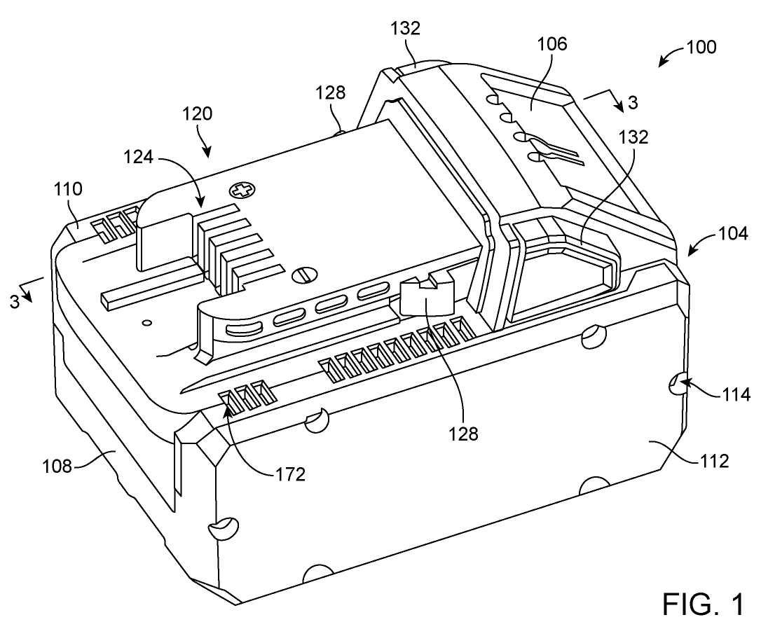

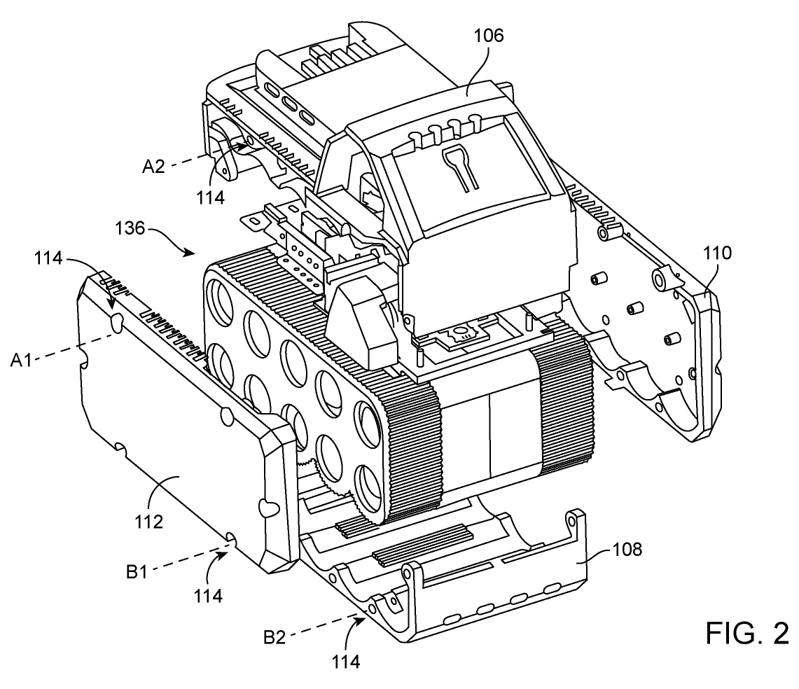

FIGS. 1 and 2 illustrate a battery pack 100 including an outer housing 104 formed to protect the electrical components stored within the battery pack from liquid ingress and physical damage. The outer housing 104 may be made from a plastic. In some constructions, the outer housing 104 may have a thermal conductivity around 1.1 W/mK (e.g., 0.9, 1.0, 1.1, 1.25, etc.). The outer housing 104 includes an upper portion 106, a lower portion 108, and opposite side portions 110, 112. In the illustrated construction, the upper portion 106 and the lower portion 108 are coupled to both the side portions 110, 112 using fasteners (not shown). As best shown in FIG. 2, each of the upper portion 106, lower portion 108, and side portions 110, 112 may include at least one bore 114 for receiving a fastener. The respective bores 114 may be aligned such that a fastener extends through the respective bores 114 of the side portions 110, 112 and into bores 114 of the upper portion 106 and lower portion 108, respectively. For example, during assembly, the upper portion 106 and the side portion 112 may be aligned such that axis A1 aligns with axis A2. A fastener may then be passed through the respective bores 114 of the side portion 112 and the upper portion 106, thereby coupling the upper portion 106 and the side portion 112. Similarly, the lower portion 108 and the side portion 112 may be aligned such that axis B1 aligns with axis B2. A fastener may then be passed through the respective bores 114 of the side portion 112 and the lower portion 108, coupling the lower portion 108 and the side portion 112.

In the illustrated example, the axis A1, B1 are perpendicular to the longitudinal axis of the battery pack 100 and extend from one side portion 112 toward the other side portion 110. Said another way, fasteners are received by the outer housing 104 in a direction parallel to the longitudinal axis of the battery cells. In other constructions, the axis A1, B1 extend from one of the upper portion 106 to the lower portion 108 or from the lower portion 108 to the upper portion 106. In some constructions, the upper portion 106 and the lower portion 108 may additionally or alternatively snap-fit to one another. Together, each of the upper portion 106, the lower portion 108, and the side portions 110, 112 cooperate to form a cavity 116 within the outer housing 104.

The upper portion 106 of the battery pack 100 additionally includes a tool interface 120 that is mechanically and electrically couplable to a power consumption device, such as a power tool or another electric device. The tool interface 120 is shaped and sized to fit within an opening or receptacle in a corresponding electrical device and includes a plurality of terminals 124 and a latch 128. The terminals 124 mechanically contact and electrically couple with corresponding terminals of the electrical device. The latch 128 is coupled to a corresponding button 132 to operatively couple the tool interface 120 to a corresponding electric device. More specifically, the latch 128 engages a corresponding recess formed in the electrical device to secure the battery pack 100 in place. The latch 128 is normally biased in an outward position (i.e., away from the tool interface 120) due to the resiliency of the material of the latch 128. Engaging (e.g., depressing) the button 132 moves the latch 128 inward towards and partially into the tool interface 120 and out of engagement with the recesses such that the battery pack 100 may be pulled out of the receptacle and away from the electrical device. In some constructions, a single latch 128 and/or button 132 are included in the battery pack 100. In the illustrated embodiment, two latches and buttons (only one pair of which is shown) are disposed on opposite sides of the battery pack 100.

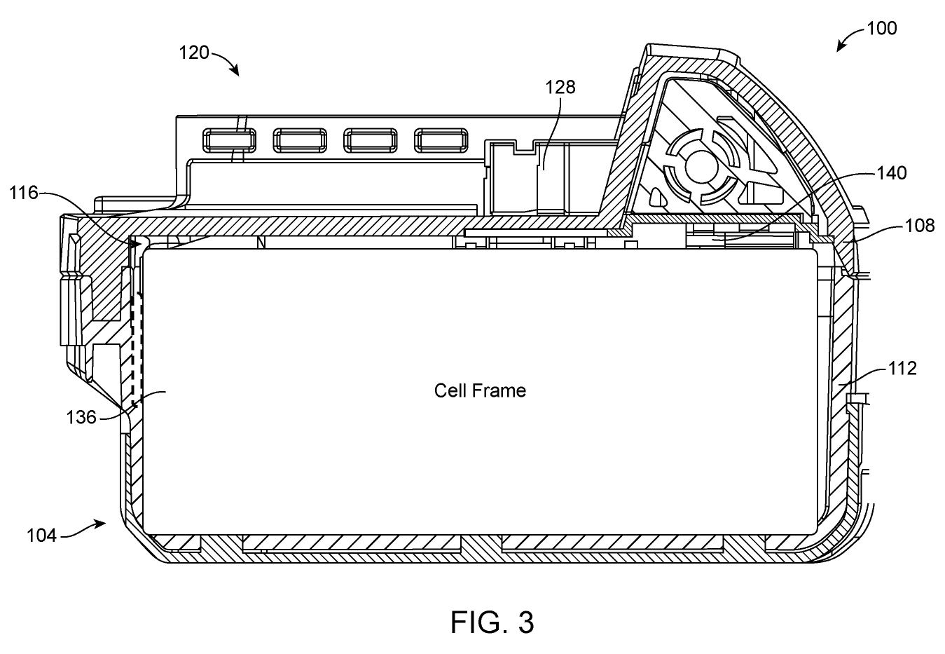

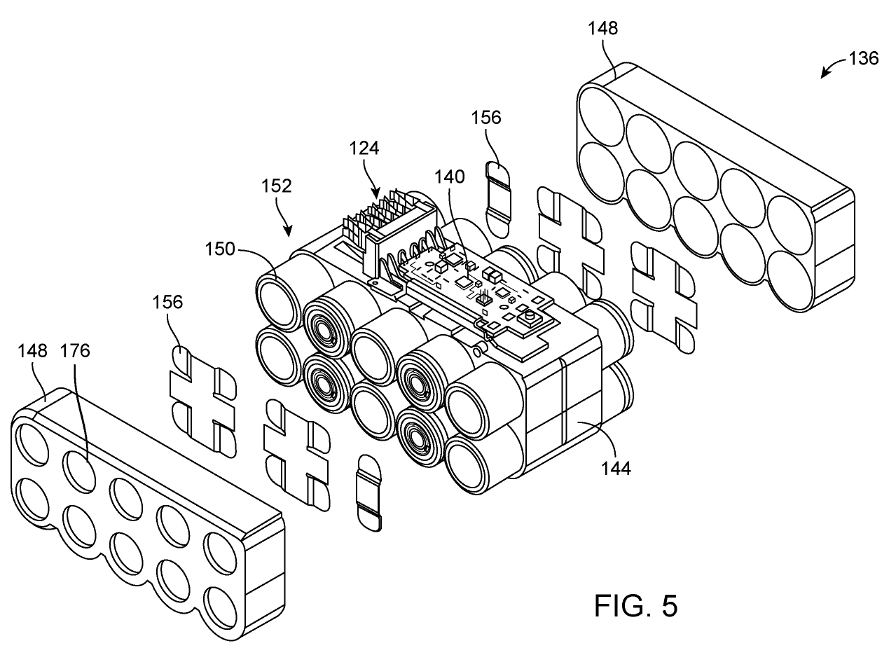

With reference to FIGS. 3-5, the battery pack 100 further includes a cell frame 136 and a printed circuit board (“PCB”) 140 supported within the cavity 116 of the outer housing 104. The PCB 140 is electrically coupled to the terminals 124 of the tool interface 120 and regulates the power transferred to and from the battery pack 100. The cell frame 136 defines a cell core 144 and a plurality of cell end frames 148 disposed on opposite ends of the cell core 144. As best shown in FIG. 5, the cell core 144 includes a plurality of apertures 152 for receiving and supporting a corresponding plurality of battery cells 150. Said another way, the battery cells 150 are secured within the apertures 152 of the cell core 144. In some constructions, the battery cells 150 are cylindrical in shape and define a cell can and opposite cell headers. In other constructions, other types of batteries (e.g., pouch cell, prismatic cell, etc.) may be implemented. In some constructions, the cell core 144 may be formed of a rubber or plastic material. In some constructions, an adhesive or padding material may be incorporated within the apertures 152 for preventing movement of the battery cells 150 within the apertures 152 and for reducing vibrations transferred between the cell frame 136 and the battery cells 150.

The battery cells 150 provide operational power (e.g., DC power) to a hand-held power tool through the terminals 124. The battery cells 150 can be arranged in series, parallel, or a series-parallel combination. In the illustrated construction, the cell core 144 supports ten battery cells 150. In some constructions, the battery pack 100 may include a different quantity of battery cells 150, which may be connected in series, parallel, or a series-parallel combination to produce a battery pack that has a desired combination of nominal battery pack voltage and battery capacity. The illustrated battery cells 150 are cylindrical battery cells. The battery cells 150 may have different sizes or shapes according to their power capacities. For example, the battery cells may be 14500 battery cells (14 mm diameter and 50 mm length), 17500 battery cells (17 mm diameter and 50 mm length), 18500 battery cells (18 mm diameter and 50 mm length), 26700 battery cells (26 mm diameter and 70 mm length), or other battery cells. The battery cells 150 are lithium-based battery cells having a chemistry of, for example, lithium-cobalt (“Li—Co”), lithium-manganese (“Li—Mn”), or Li—Mn spinel. The battery cells 150 have other suitable lithium or lithium-based chemistries, such as a lithium-based chemistry that includes manganese.

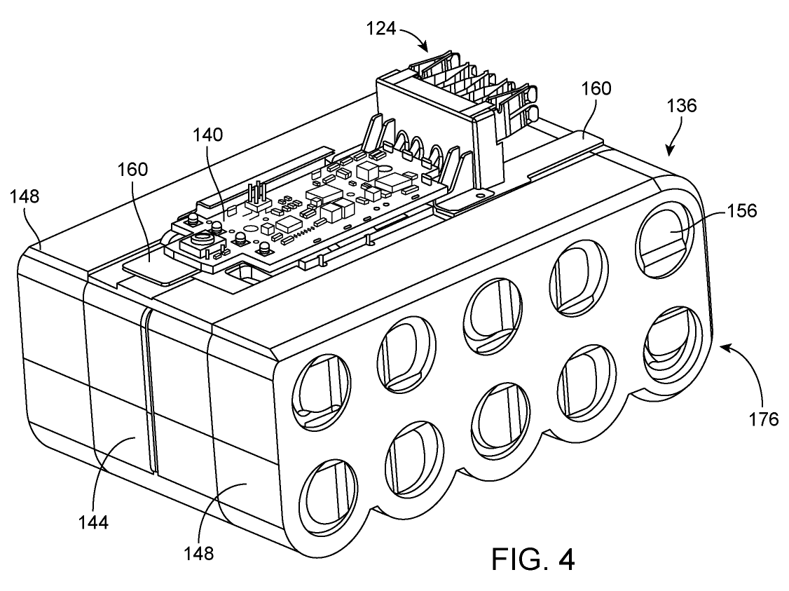

With continued reference to FIGS. 4 and 5, the battery pack 100 further includes a plurality of conductive straps 156 that are coupled (e.g., welded, soldered, etc.) to the battery cells 150 and a plurality of busbars 160. The conductive straps 156 are electrically and communicatively connected to the PCB 140 such that the battery cells 150 may provide power to the terminals 124. The busbars 160 are disposed adjacent to the cell core 144 and interconnect the battery cells to one another through the conductive straps 156 and couple the battery cells 150 to the PCB 140 and terminals 124. The busbars may be made of metal. The busbars 160 may connect the battery cells in series, parallel, or a combination thereof. The PCB 140 may control the power transferred between the battery cells and the terminals 124 of the tool interface 120. In the illustrated construction, each of the busbars 160 is integrally formed as a single piece. In other constructions, the busbars may be formed using a plurality of pieces coupled together. In yet other constructions, the busbars are incorporated within the cell end frames 148.

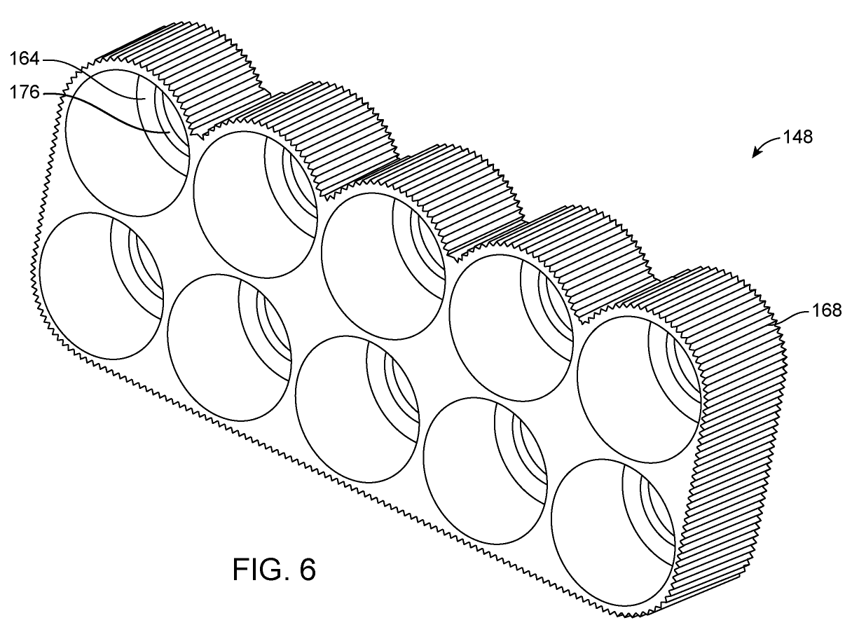

With reference to FIGS. 5-6, the cell end frames 148 are configured to contact and partially surround portions of the battery cells 150. The cell end frames 148 absorb heat from the battery cells 150. In some constructions, the cell end frames 148 surround at least half (i.e., a majority of) the surface area of the battery cells 150. In the illustrated construction, two cell end frames 148 are placed on top of the conductive straps 156 on opposite ends of the battery cells 150. Accordingly, the cell end frames 148 may also contact and partially surround portions of the conductive straps 156. In some embodiments, the conductive straps 156 may be insert-molded with the cell end frames 148. In such embodiments, the conductive straps 156 may first be insert-molded to the cell end frames 148 and then subsequently coupled to the battery cells 150 (e.g., by welding, by wire or ribbon bonds, or any other suitable manner). The cell end frames 148 are formed from a material with a high thermal conductivity, such that the cell end frames 148 may act as heat sinks for the battery cells 150. For example, the cell end frames 148 may have a thermal conductivity equal to or greater than 2.0 watts per meter kelvin (W/mK), including 2.5 W/mK and/or 3.0 W/mK. In some constructions, the material of the cell end frames 148 may have over twice the thermal conductivity of the material of the outer housing 104. The cell end frames may have a Shore A hardness greater than or equal to 40 (e.g., 50, 60, 70, between 40-70, 80, etc.). The cell end frames 148 may be made from a metal, a plastic or polymer, graphene, or another sufficiently thermally conductive material.

The cell end frames 148 may include a cap portion 164 for contacting the cell header and conductive straps 156 and a plurality of fins 168 spanning the perimeter of each of the cell end frames 148 (FIG. 6). The fins 168 dissipate heat from the battery cells by increasing the available surface area for heat to transfer between the cell end frames 148 and the environment. Additionally, in some constructions, the outer housing 104 may include a plurality of vents 172 (FIG. 1) adjacent to the fins 168 for heat to escape from the cavity 116. The cell end frames 148 may partially protect the battery cells 150 from liquid or particulate received through the vents 172. The cell end frames 148 may also include openings 176 disposed adjacent to the cell headers of the battery cells 150. Said another way, the cell headers may be exposed to the outer housing 104 through the openings 176. In some constructions, the openings 176 provide an outlet for the conductive straps 156 to displace and disconnect from the battery cells 150. The openings 176 may also provide a flow path for hot gases or cell ejecta during a thermal runaway event. It will be appreciated that the openings accordingly may protect the battery cells 150 during a thermal runaway event by cutting off current from a failing cell and by providing an outlet for hot material to flow away from the battery cells.

In some constructions, rather than being an integral portion of the cell end frame 148, the cap portion 164 may be defined by a separately formed cell end plate coupled to an end of each cell end frame 148. The cell end plate may be coupled to the cell end frame 148 using fasteners, a snap fit, adhesive, or another coupling method. The cell end plate may further include through-holes adjacent to the openings 176 such that the conductive straps 156 may be exposed. In some constructions, the cell end plates may additionally include fins extending adjacent to the fins 168. Additionally, or alternatively, the cell end plates may include fins extending away from the battery cells 150 along the cell end plates in a direction parallel to the longitudinal axis of the battery cells 150.

Although the disclosure has been described with reference to certain preferred aspects, variations and modifications exist within the scope and spirit of one or more independent aspects of the disclosure as described.

Various features and aspects of the disclosure are set forth in the following claims.

What is claimed is:

1. A battery pack comprising:
a housing made from a first material having a first thermal conductivity, the housing defining a cavity, and an interface configured to couple to a power consumption device; and
a cell frame supported within the cavity of the housing, the cell frame including
a cell core including a plurality of apertures to support a plurality of battery cells,
a first cell end frame disposed adjacent to the cell core, the first cell end frame surrounding a first portion of the battery cells, and
a second cell end frame disposed adjacent to the cell core opposite the first cell end frame, the second cell end frame surrounding a second portion of the battery cells;
wherein the first cell end frame and the second cell end frame are made from a second material having a second thermal conductivity greater than the first thermal conductivity.

2. The battery pack of claim 1, wherein the first cell end frame surrounds a first end of the battery cells and the second cell end frame surrounds a second end of the battery cells.

3. The battery pack of claim 2, wherein the first cell end frame and the second cell end frame surround a majority of a surface area of each of the plurality of battery cells.

4. The battery pack of claim 1, further comprising a plurality of conductive straps coupled to the battery cells.

5. The battery pack of claim 4, wherein the first cell end frame and the second cell end frame each include an end plate with through-holes to expose the conductive straps.

6. The battery pack of claim 5, wherein the conductive straps are molded in the first cell end frame or the second cell end frame, or the conductive straps are positioned between the battery cells and the end plate.

7. The battery pack of claim 1, wherein the second thermal conductivity is equal to or greater than 2.0 watts per meter kelvin.

8. The battery pack of claim 1, wherein the first cell end frame and the second cell end frame each have a Shore A hardness greater than or equal to 40 and less than or equal to 70.

9. The battery pack of claim 1, wherein the first cell end frame and the second cell end frame each have a hardness greater than that of the cell core, and wherein the interface is fixed to the cell core.

10. The battery pack of claim 1, wherein the first cell end frame includes a first plurality of fins spanning a perimeter of the first cell end frame and wherein the second cell end frame includes a second plurality of fins spanning a perimeter of the second cell end frame.

11. The battery pack of claim 10, wherein the housing includes a plurality of vents disposed adjacent to the first plurality of fins and the second plurality of fins.

12. The battery pack of claim 1, wherein the second thermal conductivity is at least twice the first thermal conductivity.

13. The battery pack of claim 1, wherein the housing further includes
an upper portion defining the interface,
a lower portion opposite the upper portion,
a first side portion disposed between the upper portion and the lower portion, and
a second side portion disposed between the upper portion and the lower portion, the second side portion positioned opposite the first side portion,
wherein the upper portion, the lower portion, the first side portion, and the second side portion cooperate to form the cavity.

14. The battery pack of claim 13, wherein the upper portion is coupled to the first side portion through a first fastener, and the first side portion is coupled to the lower portion through a second fastener.

15. The battery pack of claim 13, wherein each of the upper portion, the lower portion, the first side portion, and the second side portion include at least one bore for receiving a fastener along a direction parallel to longitudinal axes of the plurality of battery cells.

16. The battery pack of claim 1, wherein the housing includes a top housing and a bottom housing, the bottom housing forms the cavity.

17. A battery pack comprising:
a housing defining a plurality of vents; and
a cell frame supported within the housing, the cell frame including
a cell core including a plurality of apertures to secure a plurality of battery cells, and
a cell end frame disposed adjacent to the cell core, the cell end frame surrounding a first portion of the plurality of battery cells and defining a first plurality of fins spanning a perimeter of the cell end frame.

18. The battery pack of claim 17, wherein the plurality of vents is disposed adjacent to the first plurality of fins such that heat is dissipated from the first plurality of fins through the plurality of vents.

19. The battery pack of claim 17 further comprising a plurality of conductive straps coupled to the battery cells, wherein the plurality of conductive straps is disposed between the plurality of battery cells and the cell end frame.

20. The battery pack of claim 19, wherein the cell end frame defines a plurality of openings disposed adjacent to the plurality of battery cells.

21. The battery pack of claim 17, wherein the cell end frame is made of a material having a thermal conductivity equal to or greater than 2.0 watts per meter kelvin.
